(19) United States
(12) Patent Application Publication
(10) Pub. No.: US 2011/0315228 A1
(43) Pub. Date: Dec. 29, 2011

(54) FLUID CONTROL METHOD AND FLUID CONTROL DEVICE

(75) Inventor: Hiroshi Yokota, Osaka (JP)

(73) Assignee: KURASHIKI BOSEKI KABUSHIKI KAISHA, Kurashiki-shi, Okayama (JP)

(21) Appl. No.: 13/201,155

(22) PCT Filed: Feb. 10, 2010
(86) PCT No.: PCT/JP2010/051973

§ 371 Date: Aug. 11, 2011

(30) Foreign Application Priority Data
Feb. 12, 2009 (JP) 2009-030366

(51) Int. Cl. F15D 1/00

(52) U.S. Cl. 137/1; 137/561 R

(57) ABSTRACT

A plurality of fluids are accurately and quickly mixed such that a target characteristic is attained. A fluid control device is provided with flow channels (5, 7, 11,13) for allowing a plurality of to-be-mixed fluids to flow; flow channels (15, 17) for allowing a mixed fluid to flow; a pump (19) for shifting the fluids in the flow channels; flow rate adjusting units (11b, 13b) for respectively adjusting flow rates of a plurality of to-be-mixed fluids; a measuring unit (15a) for optically measuring a characteristic of the mixed fluid; and a control unit (21) that controls the flow rate adjusting units (11b, 13b) to adjust the flow rates of the to-be-mixed fluids based on a result of the measurement of the measuring unit (15a), such that the mixed fluid attains a target characteristic.

### BACKGROUND OF THE INVENTION

1. Field of the Invention

The present invention relates to a control method and a control device of a fluid flowing inside a flow channel. In particular, the present invention relates to a fluid control method and a fluid control device for mixing a plurality of fluids to obtain a fluid having a target characteristic.

2. Description of the Related Art

In connection with a device for mixing a plurality of liquids, there is a technique of setting a flow rate by a discharge rate of each pump for a certain time period or an opening degree of each valve, and mixing liquids by respective flow rates per certain time period, to prepare a target mixture liquid (e.g., see Patent Documents 1 and 2).

Further, as a technique of using a liquid being a mixture of a plurality of liquids, there is an etching technique of silicon wafers, for example. As an etching solution of such silicon wafers, a mixed acid being a mixture of a plurality of types of acid is used (e.g., see Patent Documents 3 to 5). Since the etch rate varies depending on the composition of an etching solution, it is very important to maintain the composition.

For example, in a case of a mixed acid containing hydrofluoric acid, nitric acid, and hexafluorosilicic acid, in the process of etching a silicon wafer, the hydrofluoric acid and the nitric acid are used in reactions and continue to reduce. In contrast thereto, the hexafluorosilicic acid and water are generated by the reactions and continue to increase. When regenerating the etching solution after being used for the etching process, as to the reduced hydrofluoric acid and the nitric acid, adding the hydrofluoric acid stock solution and the nitric acid stock solution to the etching solution, the desired hydrofluoric acid concentration and the nitric acid concentration can be recovered. Further, by adding the hydrofluoric acid stock solution and the nitric acid stock solution, the hexafluorosilicic acid and the water in the etching solution somewhat reduce. However, a reduction in the amount of the hexafluorosilicic acid and the water in the etching solution by addition of the hydrofluoric acid stock solution and the nitric acid stock solution is limited. Therefore, an operation of extracting the etching solution becomes necessary in the regeneration step of the etching solution. For example, in Patent Document 3, such an extracted etching solution is subjected to processing, to reduce the hexafluorosilicic acid and the water. Further, in Patent Document 5, a concentration measurement of an etching solution contained in an etching bath is carried out; an acid stock solution is supplied to the etching bath based on the measurement result; and the etching solution in the etching bath is discharged, whereby regeneration of the etching solution is realized. As to a measurement device of a mixed acid, there is a technique disclosed in Patent Document 6.

### PRIOR ART DOCUMENTS

### Patent Document

Patent Document 1: Japanese Unexamined Patent Application Publication (Translation of PCT Application) No. 2001-509260
Patent Document 2: Japanese Unexamined Patent Application Publication No. 2007-155494
Patent Document 3: Japanese Unexamined Patent Application Publication No. 2005-210144
Patent Document 4: Japanese Unexamined Patent Application Publication No. 11-194120
Patent Document 5: Japanese Unexamined Patent Application Publication No. 2005-187844
Patent Document 6: U.S. Pat. No. 3,578,470

In a device for mixing a plurality of liquids, a discharge rate of a pump varies temporally due to variations in a viscosity caused by variations in temperature or composition of the liquid, or a discharge error of the pump itself. Further, since an opening degree of a valve varies over the course of time, or varies due to variations in the viscosity of the liquid, the flow rate varies temporally even when the opening degree is identical.

In Patent Document 1, while a plurality of micropumps are used, these micropumps cannot have an identical capability. Therefore, a deviation from a prescribed mixture ratio occurs in the liquid after being mixed. Further, there is a danger that the prepared liquid deviates greatly from a target value, due to any failure of the pumps and valves.

Further, in some cases, any to-be-mixed liquid may be replaced by a totally different liquid due to some kind of trouble, or because of its being a volatile liquid, the solvent may vaporize, causing the liquid to have a higher concentration than a set concentration. In such a case, a liquid of a concentration which is totally different from the expected concentration is prepared. Such a liquid invites many troubles when used. For example, when the liquid is used in a production line, it is feared that many defective items are produced. Further, in a case of fuel supply to an engine, it may cause the engine to stop. Still further, in a case of a fuel cell, it invites a problem of a reduction in power generation efficiency.

Further, Patent Document 2 discloses an attempt to install a container for temporarily storing a mixed liquid, so as to eliminate discharge variations due to variations in a pump back pressure associated with variations in a viscosity of oil and that of fuel. According to this method, since the liquid is temporarily stored in the container, in some cases, the liquid is unnecessarily accumulated in the container. Hence, the liquid may denature over the course of time. Further, in the container, the liquid previously prepared is not always pushed out, but accumulates and denatures. This may mix into the supply side gradually by a small amount, and may invite troubles. Further, control for dynamically varying the mix ratio of the mixed liquid cannot be realized in terms of structure. Further, there is a fatal drawback that the size of the container prevents miniaturization and an achievement of a micro system.

Further, when regenerating an etching solution made up of a mixed acid, using the measurement technique of Patent Document 6, an acid concentration in the etching solution can be quickly and correctly measured. However, since the acid concentration in the etching solution is prone to vary by many conditions, by the etching condition, the acid concentration in the etching solution greatly varies. The process naturally stabilizes if the acid concentration in the etching solution can be measured at high speeds and accurately before and after the etching process, and a stock solution is added based on the values. However, this cannot be achieved by the conventional technique.

Further, as to any components that increase in the etching solution, e.g., water, hexafluorosilicic acid and the like when used in the etching process, such components make the processing complicated. Under a high temperature condition around 150° C., the water and the hexafluorosilicic acid continue to reduce because of their higher volatility as compared to other acid components. However, since there are no means for measuring their amounts of reduction at high speeds and accurately, there is a problem that the progress of the process cannot be adjusted.

As it stands now, the etching solution is extracted, and at a stage where a certain amount of the solution is accumulated, high-temperature heating and decompressing are performed, to reduce the water and the hexafluorosilicic acid as far as possible. Thereafter, a concentration of each of the components of the liquid is measured in a batch process, or a reduction in an amount of the water and that of the hexafluorosilicic acid are estimated. Then, the liquid and the etching solution before being used for the etching process are mixed at a prescribed mixture ratio. Thus, the overall amount of the etching solution is saved.

Further, Patent Document 5 employs a method of measuring an acid concentration in an etching solution by spectrometry in real time. Then, adjustment of the acid concentration is performed by controlling an increase or a reduction in a predetermined acid concentration for the etching solution in the etching bath. Accordingly, a stock solution container of the acid solution and a device for removing the eluted substance in the etching solution both become of a large scale. The amount of chemical solution stored and accumulated is great, and turnover of the chemical solution is poor.

### SUMMARY OF THE INVENTION

An object of the present invention is to provide a fluid control method and a fluid control device that can accurately and quickly mix a plurality of fluids to achieve a target characteristic.

A fluid control method according to the present invention includes: mixing a plurality of to-be-mixed fluids flowing inside a flow channel while adjusting their respective flow rates; optically measuring a characteristic of a mixed fluid flowing inside the flow channel; and adjusting the flow rates of the to-be-mixed fluids such that the mixed fluid achieves a target characteristic based on a result of the measurement.

A fluid control device according to the present invention includes: a flow channel for allowing a plurality of to-be-mixed fluids and a mixed fluid of the plurality of fluids to flow; a flow rate adjusting unit for adjusting a flow rate of each of the plurality of to-be-mixed fluids; a measuring unit for optically measuring a characteristic of the mixed fluid flowing inside the flow channel; and a control unit that controls the flow rate adjusting unit such that the mixed fluid attains a target characteristic based on a result of the measurement of the measuring unit, to adjust flow rates of the to-be-mixed fluid.

When mixing to-be-mixed fluids each of whose characteristic, e.g., concentration, is known, the characteristic of the resultant mixed fluid is optically measured. Based on that measurement result, to what extent the characteristic of the mixed fluid deviates from a prescribed target value is obtained. Then, a flow rate of each of the to-be-mixed fluids is controlled to correct such an obtained deviation, such that the mixed fluid approximates a target mix ratio. The optical measurement of the mixed fluid can be carried out at a fast speed of not more than a few seconds. The adjustment of the flow rate of each of the to-be-mixed fluids can also be carried out by a fast operation of no more than a few seconds. Thus, the fluid having a prescribed characteristic can quickly be prepared.

The fluid control method of the present invention may further include optically measuring a characteristic of each of the plurality of to-be-mixed fluids.

In the fluid control device of the present invention, the measuring unit may optically measure a characteristic also as to each of the plurality of to-be-mixed fluids.

In the fluid control method and the fluid control device of the present invention, the optical measurement may exemplarily be a spectrum measurement, or one of a transmittance measurement and an absorbance measurement with a prescribed wavelength. For example, a wavelength range of the spectrum measurement is one of a near-infrared spectrum of 800 to 2600 nm (nanometer), a visible radiation spectrum of 400 to 800 nm, an ultraviolet radiation spectrum of 150 to 400 nm, and a combination of them.

In the fluid control method of the present invention, adjusting the flow rates of the fluids inside the flow channel may exemplarily be carried out by varying a temperature of each of the fluids flowing in the flow channel, to vary a viscosity of each of the fluids.

In the fluid control device of the present invention, the flow rate adjusting unit may exemplarily vary the temperature of each of the fluids inside the flow channel, to vary the viscosity of each of the fluids, and to adjust the flow rates of the fluids inside the flow channel.

However, in the fluid control method and the fluid control device of the present invention, adjustment of the flow rate of each of the fluids is not limited to those carried out by the temperature, and it may be carried out by another method, e.g., opening or closing of a valve, or by an opening degree.

In the fluid control method and the fluid control device of the present invention, the flow channel may exemplarily be formed with a tube.

In the fluid control method and the fluid control device of the present invention, the flow channel may exemplarily be formed inside a microfluidic device. One example of the microfluidic device is a chip including two flat plates clamping a partition plate of a uniform thickness therebetween, such that the flow channel is formed inside.

For example, when the flow channel is a tube piping on a mm (millimeter) unit basis using a piping system structured with proportional control valves, the fluid control method and the fluid control device of the present invention can be implemented. Further, it is also possible to constitute the present invention with a microfluidic device having a flow channel formed by an etching technique inside a substrate measuring some mm to some μm (micrometer).

When the flow channel has a normal size, the optical measurement is carried out by: for example, transporting a fluid to a light-transmissive cell unit made of glass; emitting light thereto; and receiving the light that has transmitted through the fluid. In a case where a microfluidic device is used, a fluid is transported to a flow channel in the microfluidic device, and measurement is carried out by transmitting and receiving light by, e.g., optical fibers, through a prescribed cell portion. Thus, an optical measurement of a plurality of measurement points can easily be carried out. Further, allotting pure water or the like as the calibration solution to one of a plurality of cells, it becomes easier to calibrate a spectroscope including the optical fiber system, by measuring the cell portion where the pure water is contained. Thus, it becomes possible to secure reliability for a long period and stability of measurement values.

The flow rate control of each fluid can be performed by a proportional valve, for example. However, using any method that exploits variations in the viscosity of the liquid caused by temperatures, the microfluidic device can easily be implemented.

In the fluid control method and the fluid control device of the present invention, the fluids may exemplarily each be a liquid. However, the fluids in the fluid control method and the fluid control device of the present invention are not limited to liquids, and the fluids may each be a gas.

In the fluid control method and the fluid control device of the present invention, the characteristic of each of the fluids may exemplarily be a temperature of each of the fluids, or a concentration of a composition constituting each of the fluids. It is to be noted that the characteristic of each of the fluids in the fluid control method and the fluid control device of the present invention is not limited thereto.

In the fluid control method and the fluid control device of the present invention, in a case where the fluids are each a liquid, and the characteristic of each of the fluids is a concentration of a composition constituting each of the liquids, the to-be-mixed fluids may exemplarily be an alcohol solution and water, and the mixed fluid may exemplarily be a diluted alcohol solution.

In the fluid control method and the fluid control device of the present invention, in a case where the fluids are each a liquid, and the characteristic of each of the fluids is a concentration of a composition constituting each of the liquids, the to-be-mixed fluids may exemplarily be a mixed acid before having its concentration adjusted, an acid solution of a component of the mixed acid, and water, and the mixed fluid may exemplarily be a mixed acid after having its concentration adjusted.

In a case where the to-be-mixed fluids include a mixed acid before having its concentration adjusted, in the fluid control method of the present invention, a moisture content in the mixed acid before having its concentration adjusted may exemplarily be reduced by one of or both of a heating process and a decompressing process. Further, the fluid control device of the present invention may further include a removing unit for reducing a moisture content in the mixed acid before having its concentration adjusted by one or both of a heating process or a decompressing process.

One example of the mixed acid before having its concentration adjusted is a solution being the mixed acid after having its concentration adjusted having undergone a prescribed process.

One example of the component of the mixed acid includes at least two out of hexafluorosilicic acid, hydrofluoric acid, nitric acid, acetic acid, phosphoric acid, and sulfuric acid.

Further, other examples of the component of the mixed acid includes hexafluorosilicic acid, and further includes at least one of hydrofluoric acid, nitric acid, acetic acid, phosphoric acid, and sulfuric acid. It is to be noted that in the fluid control method and the fluid control device of the present invention, the component of the mixed acid is not limited thereto.

In a case where the to-be-mixed fluids include a mixed acid containing hexafluorosilicic acid, in the fluid control method of the present invention, a content of the hexafluorosilicic acid component in the mixed acid before having its concentration adjusted may be reduced by one or both of a heating process and a decompressing process, and further, the moisture content in the mixed acid before having its concentration adjusted may also be reduced. Further, the fluid control device of the present invention may further include a removing unit for reducing a content of the hexafluorosilicic acid component in the mixed acid having its concentration adjusted by one of or both of a heating process or a decompressing process. The removing unit may also reduce the moisture content in the mixed acid before having its concentration adjusted together with reducing the hexafluorosilicic acid component amount.

In the fluid control method and the fluid control device of the present invention, in a case where the mixed acid before having its concentration adjusted, which is one of the to-be-mixed fluids, is the mixed acid after having its concentration adjusted having undergone a prescribed process, an example of the prescribed process may be an etching process of a silicon wafer. Further, the mixed acid before having its concentration adjusted may exemplarily be the mixed acid after having its concentration adjusted having undergone the etching process of the silicon wafer in the number of unit pieces. One example of the etching process is a spin etching process.

With the fluid control method of the present invention, a plurality of to-be-mixed fluids flowing inside a flow channel are mixed while having their respective flow rates adjusted; a characteristic of a mixed fluid flowing inside the flow channel is optically measured; and flow rates of the to-be-mixed fluids are adjusted such that the mixed fluid achieves a target characteristic, based on a result of the measurement.

With the fluid control device of the present invention, by a flow channel for allowing a plurality of to-be-mixed fluids and a mixed fluid of the plurality of fluids to flow, a pump for shifting the fluids inside the flow channel, a flow rate adjusting unit for adjusting a flow rate of each of the plurality of to-be-mixed fluids, and a measuring unit, a characteristic of a mixed fluid flowing inside the flow channel is optically measured, and by a control unit, the flow rate adjusting unit is controlled such that the mixed fluid achieves a target characteristic based on the measurement result of the measuring unit, to adjust the flow rates of the to-be-mixed fluids.

Thus, with the fluid control method and the fluid control device of the present invention, a plurality of fluids can accurately and quickly be mixed inside the flow channel such that a target characteristic thereof is achieved.

In the fluid control method of the present invention, a characteristic may optically be measured as to each of the plurality of to-be-mixed fluids.

In the fluid control device of the present invention, the measuring unit may optically measure a characteristic also as to each of the plurality of to-be-mixed fluids.

Measuring a spectrum as to each of the plurality of to-be-mixed fluids, it becomes possible to monitor the characteristic of each of the to-be-mixed fluids. For example, it becomes possible to use fluids whose characteristic is unknown as such to-be-mixed fluids. Further, it becomes possible to address a case in which any to-be-mixed fluid is replaced by a totally different fluid due to any trouble, or in a case where, because of the fluid's being a volatile liquid, the solvent is vaporized to cause the liquid to have a concentration higher than a set concentration.

In the fluid control method and the fluid control device of the present invention, in a case where: the fluids are each a liquid; the characteristic of each of the fluids is a concentration of a composition constituting the liquid; the to-be-mixed fluids are an alcohol solution and water; and the mixed fluid is a diluted alcohol solution, the fluid control method and the fluid control device of the present invention can be applied to for example a fuel cell.

Further, in a case where: the fluids are each a liquid; the characteristic of the liquid is a concentration of the composition constituting the liquid; the to-be-mixed fluids are a mixed acid before having its concentration adjusted, an acid solution of a component of the mixed acid, and water; and the mixed fluid is a mixed acid after having its concentration adjusted; and the mixed acid after having its concentration adjusted is a solution having undergone a prescribed process, the fluid control method and the fluid control device of the present invention can be applied to recycling of the mixed acid.

In a case where the prescribed process is, e.g., a spin etching process for a silicon wafer, a mixed acid containing hydrofluoric acid, nitric acid, and hexafluorosilicic acid is used as an etching solution. As to the etching solution, an acid concentration is measured before and after being used in the etching process. Thus, an increase or a reduction in the concentration of an acid component can accurately be obtained. Adding a stock solution of a higher concentration to a reduced acid component, the liquid composition before being used in the etching process can be recovered.

Adding the hydrofluoric acid stock solution and the nitric acid stock solution, the hexafluorosilicic acid and the water in the etching solution somewhat reduce. However, while the increased water and the hexafluorosilicic acid reduce to some extent, they are not fully recovered. An attempt of such a recovery invites a growing increase in the amount of added hydrofluoric acid stock solution and nitric acid stock solution, which runs counter to the principle of achieving a reduction in chemical agent usage through recycling. Accordingly, a process of reducing the increased water and the hexafluorosilicic acid becomes necessary.

While this process is complicated, it is a method that achieves the best miniaturization, including: decompressing an etching solution under a high temperature, to turn water into water vapor, and turning the hexafluorosilicic acid into silicon tetrafluoride, to be separated as a gas. Conventionally, the process is carried out in a batch-manner with a device of a large scale. However, processing just the etching solution which has been used in the etching process enables miniaturization of the device to be realized. With the fluid control method and the fluid control device of the present invention, since a reduced amount of the water and the hexafluorosilicic acid can accurately be measured in real time, the process time can appropriately be set. Thus, it becomes possible to save the time and energy required for the regeneration process of the etching solution.

Further, it becomes possible to: measure an acid concentration of the etching solution after being used in real time, without using a bath for storing the etching solution; reduce the water and the hexafluorosilicic acid in accordance with the measurement result; add the hydrofluoric acid stock solution and the nitric acid stock solution; and regenerate the etching solution. Therefore, the etching solution being regenerated can immediately be used, and turnover of the chemical agent improves. Thus, the total amount of the chemical agent being accumulated in the process can be reduced. In this manner, the fluid control method and the fluid control device of the present invention can regenerate, e.g., the etching solution, and can contribute toward improving global environmental sustainability.

Further, by employing the flow channel as being formed inside the microfluidic device in which the microfluidic device is a chip including two flat plates clamping a partition plate of a uniform thickness therebetween, such that the flow channel is formed inside, it becomes possible to uniformize the depth dimension of the flow channel in the chip, that is, the optical length, and measurement of the property of the fluid in the flow channel of the chip, e.g., measurement of the absorbance and the concentration, can accurately and stably be carried out.

### BRIEF DESCRIPTION OF THE DRAWINGS

FIG. 1 is a schematic diagram for describing an overall structure of one embodiment of a fluid control device.

FIG. 2 shows a plan view and a side view for describing a solution adjusting unit according to the embodiment.

FIG. 3 is a side view showing a chip that constitutes a portion of the solution adjusting unit.

FIG. 4 is a side view showing a glass partition plate and two glass plates before being joined to one another, which constitute the chip.

FIG. 5 is a plan view showing the glass partition plate of the chip.

FIG. 6 is a side view showing the glass plates of the chip.

FIG. 7 is a plan view for describing a flow channel pattern of the chip constituting the solution adjusting unit.

FIG. 8 is a plan view indicating a flow of a liquid in a mixing unit in the chip by arrows.

FIG. 9 is a side view showing the glass partition plate and the two glass plates before being joined to one another;

FIG. 10 shows a plan view and a side view for describing disposition of sensors, Peltier devices and temperature detectors to be disposed on the chip.

FIG. 11 shows a graph of a difference spectrum of methanol and relative to a water spectrum.

FIG. 12 shows graphs respectively showing a difference spectrum of each of hydrochloric acid, acetic acid, ethanol, glucose, and saccharose, relative to a water spectrum, at wavelengths 1700 nm to 2600 nm.

FIG. 13 shows graphs respectively showing a difference spectrum of each of hydrochloric acid, acetic acid, ethanol, glucose, saccharose, and methanol, relative to a water spectrum, at wavelengths 800 nm to 1400 nm.

FIG. 14 shows graphs respectively showing a difference spectrum of each of hydrochloric acid, acetic acid, ethanol, glucose, saccharose, and methanol, relative to a water spectrum, at wavelengths 1200 nm to 1900 nm.

FIG. 15 is a diagram schematically showing an overall structure of other embodiment of the fluid control device;

FIG. 16 is a schematic configuration diagram for describing a solution adjusting unit according to the embodiment.

FIG. 17 shows a front view, a side view and a top view for describing the structure of a measuring unit according to the embodiment.

FIG. 18 is a schematic configuration diagram for describing an optical system according to the embodiment.

### DETAILED DESCRIPTION OF THE INVENTION

As a fuel cell of a small size suitable for mobile devices, attention is being given to a direct methanol fuel cell (DMFC: Direct Methanol Fuel Cell). As a fuel supply to the DMFC-type fuel cell, an aqueous methanol solution having a methanol concentration of 3 to 5% is used. When the methanol concentration is high, what is invited is a problem of an occurrence of a crossover phenomenon, in which unreacted methanol at a fuel electrode transmits through an electrolyte membrane to arrive at an air electrode, whereby a power generation efficiency reduces. On the other hand, a low methanol concentration also invites a reduction in the power generation efficiency. Accordingly, it is desired to constantly supply the solution at an optimum methanol concentration. Further, provided that methanol of a high concentration can be used by diluting to the optimum concentration with water, it becomes possible to reduce a volume of a methanol fuel which is previously stored in the DMFC-type fuel cell, and hence it becomes possible to achieve a further miniaturization of the DMFC-type fuel cell. Water necessary for the dilution may be obtained by exploiting water that is generated on the air electrode side, or may be obtained by collecting moisture in the air.

### First Embodiment

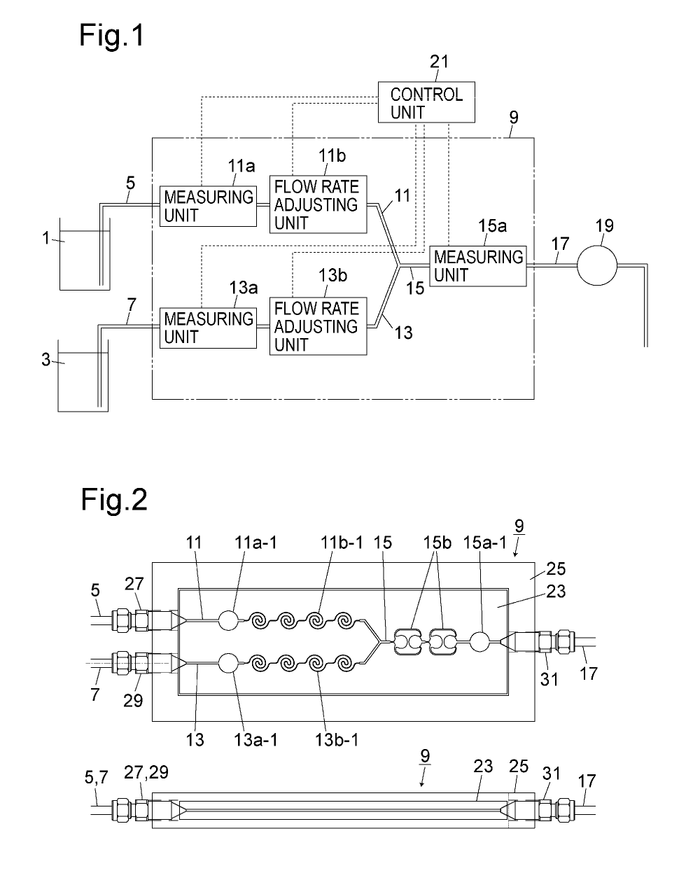

FIG. 1 is a schematic diagram for describing an overall structure of one embodiment of a fluid control device.

A container 1 that contains methanol at a 30% concentration and a container 3 that contains water are provided.

One end of a tube 5 is connected to the container 1 containing the methanol. One end of a tube 7 is connected to the container 3 containing the water. The other ends of the tubes 5 and 7 are connected to a solution adjusting unit 9.

The solution adjusting unit 9 is provided with a flow channel 11 to which the tube 5 is connected, and a flow channel 13 to which the tube 7 is connected. Ends of the flow channels 11 and 13 on the opposite sides with reference to the tubes 5 and 7 are merged with each other and connected to a flow channel 15.

The flow channel 11 is provided with a measuring unit 11a and a flow rate adjusting unit 11b, in order from the tube 5 side. The flow channel 13 is provided with a measuring unit 13a and a flow rate adjusting unit 13b, in order from the tube 7 side. The flow channel 15 is provided with a measuring unit 15a.

The measuring units 11a, 13a and 15a are for optically measuring spectrums of liquids in the flow channels 11, 13 and 15. The flow rate adjusting units 11b and 13b are for adjusting flow rates of the liquid in the flow channels 11 and 13.

To the solution adjusting unit 9, a tube 17 for allowing diluted methanol from the flow channel 15 to flow is also connected. The tube 17 is connected to a pump 19.

A control unit 21 for controlling the flow rate adjusting units 11b and 13b is provided. Based on a measurement result from each of the measuring units 11a, 13a and 15a, the control unit 21 controls the flow rate adjusting units 11b and 13b to adjust the flow rates of the methanol and the water flowing inside the flow channels 11 and 13, such that the diluted methanol in the flow channel 15 achieves a target concentration.

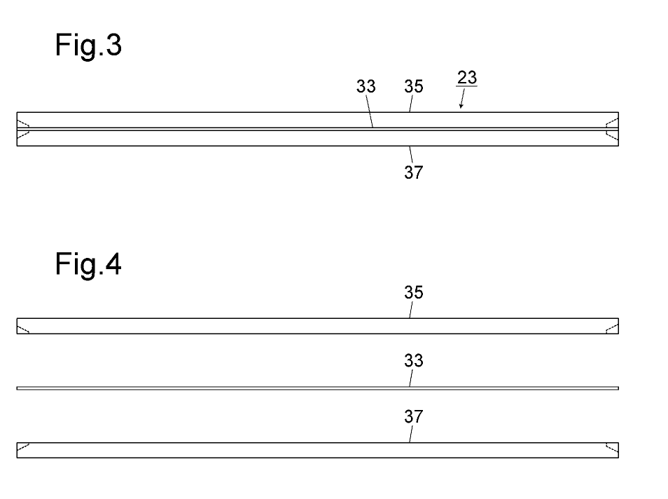

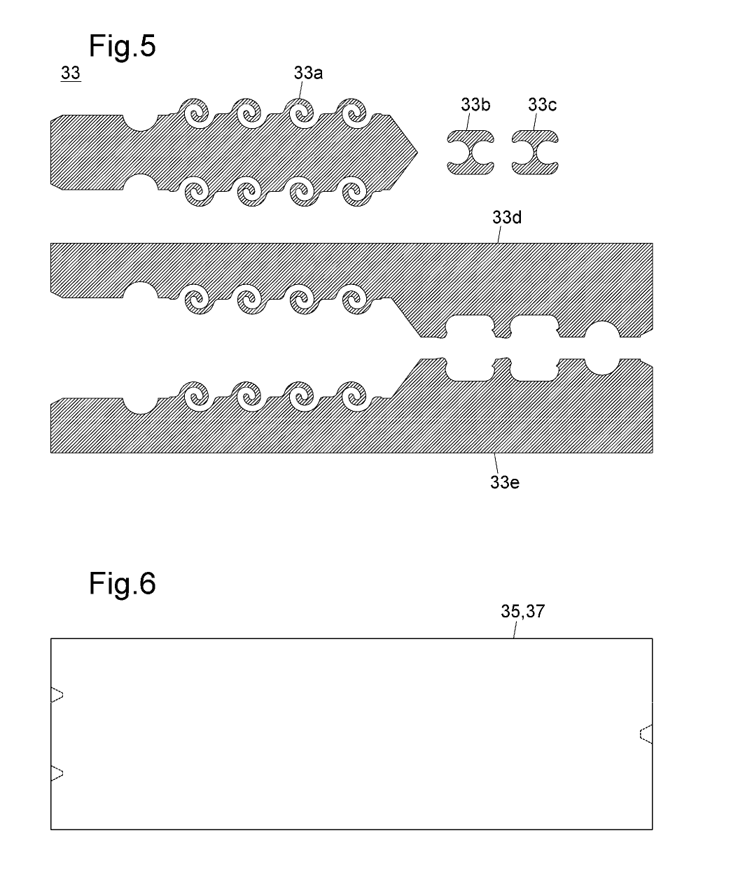

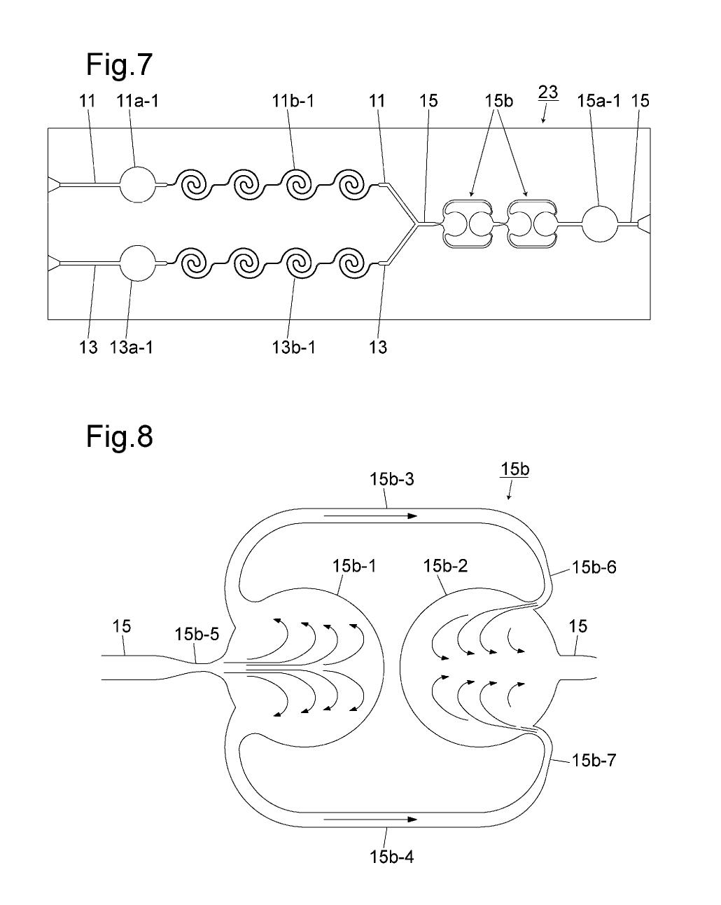

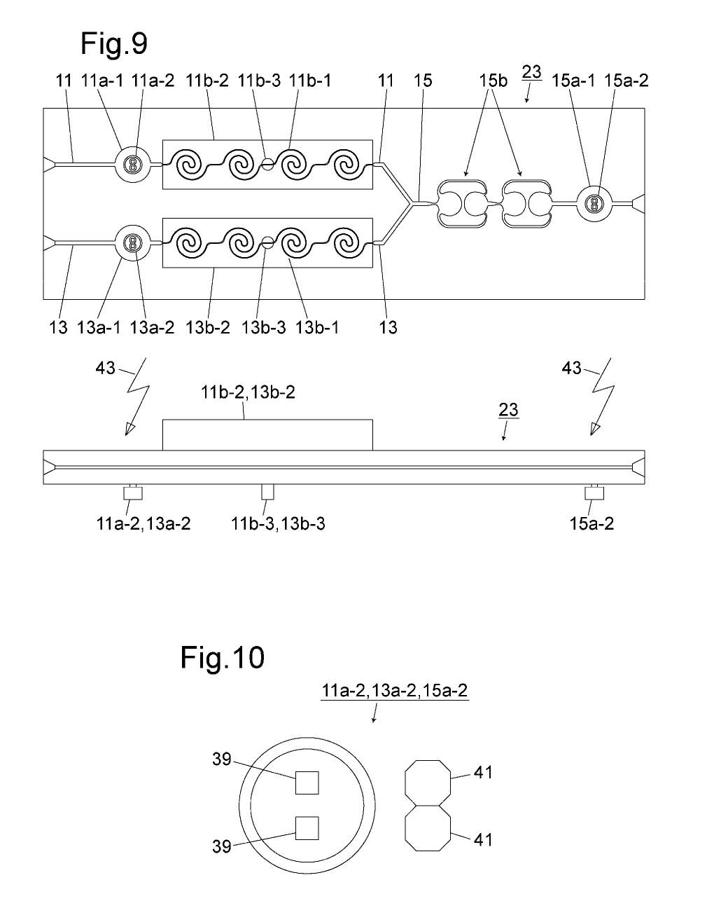

FIG. 2 shows a plan view and a side view for describing the solution adjusting unit 9. FIG. 3 is a side view showing a chip 23 that constitutes a portion of the solution adjusting unit 9. FIG. 4 is a side view showing a glass partition plate 33 and two glass plates 35 and 37 before being joined to one another, which structure the chip 23. FIG. 5 is a plan view of the glass partition plate 33 of the chip 23. FIG. 6 is a side view showing the glass plates 35 and 37 of the chip 23. FIG. 7 is a plan view for describing a flow channel pattern of the chip 23 constituting the solution adjusting unit 9. FIG. 8 is a plan view indicating the flow of a liquid in a mixing unit 15b in the chip 23 by arrows. FIG. 9 shows a plan view and a side view for describing disposition of sensors, Peltier devices and temperature detectors to be disposed on the chip 23. FIG. 10 is a plan view that shows an optical sensor to be disposed on the chip 23 in an exploded manner.

As shown in FIG. 2, the solution adjusting unit 13 is provided with the chip 23 having formed therein the flow channels, a metal-made frame unit 25 for supporting the chip 23, and joints 27, 29 and 31 for connecting the tubes 5, 7 and 17 to the chip 23. The chip 23 is a microfluidic device.

A two-dimensional size of the chip 23 is 12.5 mm×39 mm, and a thickness thereof is 2.2 mm. A two-dimensional outer circumferential size of the frame unit 25 is 19 mm×46 mm; a two-dimensional inner circumferential size thereof is 13 mm×40 mm; and a thickness thereof is 4.2 mm. Into the frame unit 25, the joints 27, 29 and 31 are inserted with screws. The chip 23 disposed on the inner side with reference to the frame unit 25 is fixed by being pressed down by the joints 27, 29 and 31. The chip 23 is provided with, at positions on its side surfaces corresponding to the joints 27, 29 and 31, tapered concave portions respectively leading to the flow channels in the chip 23. By tips of the joints 27, 29 and 31 being inserted into the concave portions on the side surfaces of the chip 23, the flow channels are sealed to prevent leakage of the fluid.

As shown in FIGS. 3 and 4, the chip 23 has a three-layered structure, in which the glass partition plate 33 having a uniform thickness for forming the flow channels is clamped between the two glass flat plates 35 and 37.

As shown in FIG. 5, the glass partition plate 33 is constituted by five glass plates denoted by reference characters 33a to 33e. The thickness of the glass plates 33a to 33e are each for example 0.2 mm.

As shown in FIG. 6, the glass flat plates 35 and 37 are processed such that just the portions to be brought into contact with the joints are tapered. The glass flat plates 35 and 37 each have a thickness of 1 mm.

The joining plane between each of the glass partition plate 33 and the glass flat plates 35 and 37 is polished to be flat. As shown in FIG. 4, between the glass flat plates 35 and 37, the glass partition plate 33 is disposed. Specifically, on the glass flat plate 37, the glass plates 33a to 33e constituting the glass partition plate 33 are disposed, and the glass flat plate 35 is disposed further thereon. In a state where the glass partition plate 33 and the glass flat plates 35 and 37 are disposed as being layered, heat is applied thereto to establish an optical contact. Thus, the glass partition plate 33 and the glass flat plates 35 and 37 are bonded to one another without the necessity of using adhesives. Then, as shown in FIG. 3, the chip 23 is formed.

As shown in FIG. 7, inside the chip 23, the two flow channels 11 and 13 to which the tubes 5 and 7 are respectively connected are provided.

The flow channels 11 and 13 are respectively provided with sensor units 11a-1 and 13a-1. The sensor unit 11a-1 is a small space used for monitoring a methanol concentration. The sensor unit 13a-1 is a small space used for monitoring a concentration of water, and whether or not any impurity such as methanol is contained is monitored.

The flow channels 11 and 13 are also provided with flow rate control units 11b-1 and 13b-1, which are disposed on the downstream side with reference to the sensor units 11a-1 and 13a-1, respectively. The flow rate control units 11b-1 and 13b-1 are each provided with four spiral flow channels connected in series. The flow rate control units 11b-1 and 13b-1 are each formed to have a smaller flow channel width, i.e., a cross-sectional area, as compared to other flow channel portions of the chip 23.

The flow channel 11 and the flow channel 13 are merged with each other downstream on the downstream side with reference to the flow rate control units 11b-1 and 13b-1, and connected to the flow channel 15.

The flow channel 15 is provided with two mixing units 15b.

The flow channel 15 is also provided with a sensor unit 15a-1 on the downstream side with reference to the mixing units 15b. The sensor unit 15a-1 is a small space used for measuring a methanol concentration after mixing is carried out.

With reference to FIG. 8, a description will be given of the flow of the liquid in the mixing unit 15b.

Each mixing unit 15b is provided with two wide portions 15b-1 and 15b-2. The wide portion 15b-1 on the upstream side and the wide portion 15b-2 on the downstream side are connected to each other with two flow channels 15b-3 and 15b-4.

To the wide portion 15b-1 on the upstream side, the flow channel 15 on the upstream with reference to the mixing unit 15b is connected. Near the wide portion 15b-1, a narrow flow channel portion 15b-5 is provided to the flow channel 15. Ends on the upstream side of the two flow channels 15b-3 and 15b-4 connecting between the wide portions 15b-1 and 15b-2 are connected to the wide portion 15b-1 at portions having the narrow portion 15b-5 interposed therebetween.

To the wide portion 15b-2 on the downstream side, the flow channel 15 on the downstream side to the mixing unit 15b is connected. Ends on the downstream side of the two flow channels 15b-3 and 15b-4 connecting between the wide portions 15b-1 and 15b-2 are connected to the wide portion 15b-2 at portions having the flow channel 15 connected to the wide portion 15b-2 interposed therebetween. Near the wide portion 15b-2, narrow flow channel portions 15b-6 and 15b-7 are provided to the flow channels 15b-3 and 15b-4, respectively.

From the flow channel 15 on the upstream side relative to the mixing unit 15b, via the narrow portion 15b-5, the liquid flows into the wide portion 15b-1. Since the liquid increases its flow velocity when passing through the narrow portion 15b-5, a vortex is produced in the wide portion 15b-1 (see arrows in the portion 15b-1 in FIG. 8). The liquid in the portion 15b-1 flows into the two flow channels 15b-3 and 15b-4. The liquid having flown into the flow channels 15b-3 and 15b-4 flows into the wide portion 15b-2 via the narrow flow channel portions 15b-6 and 15b-7. Since the liquid increases its flow velocity when passing through the narrow portions 15b-6 and 15b-7, a vortex is produced in the wide portion 15b-2 (see arrows in the portion 15b-2 in FIG. 8). By these vortexes, mixture of the liquids is promoted.

As shown in FIG. 7, since the mixing unit 15b is two-staged, through the repetition of mixing patterns shown in FIG. 8 by the two stages, the liquids are completely mixed.

With reference to FIG. 9, a description will be given of sensors, Peltier devices and temperature detectors to be disposed on the chip 23. It is to be noted that such sensors, Peltier devices and temperature detectors are not shown in FIG. 2.

On a top surface of the chip 23, two Peltier devices 11b-2 and 13b-2 are bonded. The Peltier device 11b-2 is disposed on the flow rate control unit 11b-1 through which the methanol flows. The Peltier device 13b-2 is disposed on the flow rate control unit 11b-1 through which the water flows.

On a bottom surface of the chip 23, two temperature detectors 11b-3 and 13b-3 are bonded. The temperature detectors 11b-3 and 13b-3 are made of for example platinum. The temperature detector 11b-3 is disposed below the flow rate control unit 11b-1 through which the methanol flows. The temperature detector 13b-3 is disposed below the flow rate control unit 11b-1 through which the water flows.

Also bonded to the bottom surface of the chip 23 are three optical sensors 11a-2, 13a-2 and 15a-2. The optical sensor 11a-2 is disposed below the flow rate control unit 11b-1 through which the methanol flows. The optical sensor 13a-2 is disposed below the flow rate control unit 13b-1 through which the water flows. The optical sensor 15a-2 is disposed below the flow rate control unit 15b-1 through which a diluted methanol flows.

As shown in FIG. 10, the optical sensors 11a-2, 13a-2 and 15a-2 are each provided with, for example, two InGaAs elements 39 and 39, and interference filters 41 and 41 bonded on the surface of the InGaAs elements 39 and 39. The interference filter 41 is a band-pass filter that allows just specific wavelengths to pass through. Here, the interference filters 41 and 41 are set to allow wavelength 2200 nm and wavelength 2260 nm, differing in a near-infrared spectrum attributed to the methanol and the water, to pass through.

In the present embodiment, the sensor unit 11a-1 and the optical sensor 11a-2 constitute the measuring unit 11a; the sensor unit 13a-1 and the optical sensor 13a-2 constitute the measuring unit 13a; and the sensor unit 15a-1 and the optical sensor 15a-2 constitute the measuring unit 15a.

Further, the flow rate control unit 11b-1, the Peltier device 11b-2 and the temperature detector 11b-3 constitute the flow rate adjusting unit 11b, and the flow rate control unit 13b-1, the Peltier device 13b-2 and the temperature detector 13b-3 constitute the flow rate adjusting unit 13b.

With reference to FIGS. 1 to 10, a description will be given of an operation of diluting the methanol.

When the pump 19 is actuated, the methanol in the container 1 is suctioned into the tube 5, and the water in the container 3 is suctioned into the tube 7. The methanol suctioned into the tube 5 and the water suctioned into the tube 7 are guided to the solution adjusting unit 9. The methanol and the water guided to the solution adjusting unit 9 are guided to the flow channels 11 and 13 in the chip 23. After passing through the sensor units 11a-1 and 13a-1 and the flow rate control units 11b-1 and 13b-1, the methanol and the water merge with each other at the flow channel 15, and guided to the mixing unit 15b to be mixed with each other to be the diluted methanol. After passing through the sensor unit 15a-1, the diluted methanol is guided from the flow channel 15 to the tube 17 outside the chip 23, and discharged through the pump 19.

By the control unit 21, the temperature of each of the Peltier devices 11b-2 and 13b-2 of the flow rate adjusting units 11b and 13b is controlled, and the temperature of each of the flow rate control units 11b-1 and 13b-1 is adjusted. The viscosity of each of the methanol and the water varies depending on the temperature. Upon occurrence of variations in the viscosity, the flow rate of each of the methanol and the water respectively in the flow channels 11 and 13 varies also. Accordingly, the flow rates of the methanol and the water flowing through the flow channels 11 and 13 are adjusted by the temperatures of the flow rate control units 11b-1 and 13b-1, respectively.

As shown in FIG. 9, light 43 from a tungsten lamp (not shown) is condensed by a lens (not shown), and emitted to the chip 23. The light transmitted through the sensor units 11a-1, 13a-1 and 15a-1 is received by the optical sensors 11a-2, 13a-2 and 15a-2. Here, the chip 23 has the three-layered structure in which the glass partition plate 33 having a uniform thickness is clamped by the two glass flat plates 35 and 37. Therefore, a flow channel depth, i.e., the optical length, in each of the sensor units 11a-1, 13a-1 and 15a-1 becomes uniform, e.g., 0.2 mm.

The control unit 21 shown in FIG. 1 measures a methanol concentration from an attenuation amount of the light having transmitted through the sensor units 11a-1, 13a-1 and 15a-1, based on signals from the optical sensors 11a-2, 13a-2 and 15a-2.

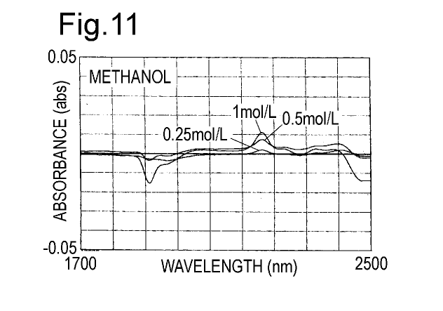

FIG. 11 shows a graph showing a difference spectrum of the methanol relative to a water spectrum. In FIG. 11, the horizontal axis indicates wavelength (nm), and the vertical axis represents absorbance (abs). FIG. 11 shows as to the following methanol concentrations: 1 mol/L (mole/liter), 0.5 mol/L, and 0.25 mol/L. The employed optical length is 0.2 mm.

The wavelength 2260 nm shows absorption related to the CH group of the methanol. The wavelength 2200 nm shows less spectrum difference between the water and the methanol. Accordingly, by measuring an absorbance difference between the wavelength 2260 nm and the wavelength 2200 nm, the methanol concentration can be obtained based on the Lambert-Beer law.

The signal from the optical sensor 11a-2 is used for checking that the methanol concentration at the sensor unit 11a-1 is 30%. When the measurement result of the methanol concentration of the sensor unit 11a-1 is not 30%, it means that the methanol of a wrong concentration is supplied. Therefore, the control unit 21 outputs an alert signal such that an alert is presented on an indicator (not shown).

The signal from the optical sensor 13a-2 is used to check that the liquid in the sensor unit 13a-1 is water. When it is not, it means that some liquid other than water is supplied. Therefore, the control unit 21 outputs an alert signal.

The signal from the optical sensor 15a-2 is used to check that the concentration of the diluted methanol in the sensor unit 15a-1 is at a target concentration. The control unit 21 calculates the concentration of the diluted methanol based on the signal from the optical sensor 15a-2. A case where the target methanol concentration is, for example, 4% shall be discussed.

When the methanol concentration calculated by the control unit 21 is higher than 4%, the control unit 21 lowers the temperature of the Peltier device 11b-2 of the flow rate adjusting unit 11b, to thereby lower the temperature of the flow rate control unit 11b-1; and the control unit 21 raises the viscosity of the methanol in the flow rate control unit 11b-1, to thereby lower the flow rate of the methanol in the flow channel 11. Further, the control unit 21 raises the temperature of the Peltier device 13b-2 of the flow rate adjusting unit 13b, to thereby raise the temperature of the flow rate control unit 13b-1; and the control unit 21 lowers the viscosity of the water in the flow rate control unit 13b-1, to thereby increase the flow rate of the water in the flow channel 13.

Conversely, when the methanol concentration calculated by the control unit 21 is lower than 4%, the control unit 21 raises the temperature of the Peltier device 11b-2 of the flow rate adjusting unit 11b, to thereby raise the temperature of the flow rate control unit 11b-1; and the control unit 21 lowers the viscosity of the methanol in the flow rate control unit 11b-1, to thereby increase the flow rate of the methanol in the flow channel 11. Further, the control unit 21 lowers the temperature of the Peltier device 13b-2 of the flow rate adjusting unit 13b, to thereby lower the temperature of the flow rate control unit 13b-1; and the control unit 21 raises the viscosity of the water in the flow rate control unit 13b-1, to thereby lower the flow rate of the water in the flow channel 13.

The control unit 21 measures the temperatures of the Peltier devices 11b-2 and 13b-2 based on the signals from the temperature detectors 11b-3 and 13b-3.

Measurement of the methanol concentration of the diluted methanol at the sensor unit 15a-1 is carried out for twenty times in one second. The control unit 21 exerts flow rate control every time the measurement is carried out, such that the methanol concentration becomes constant substantially in real time and continuously.

The relationship among the methanol temperature, the water temperature and the methanol concentration that can be obtained through this method is shown in Table 1.

TABLE 1

| | METHANOL-SIDE SET | | | | |
|---|---|---|---|---|---|
| METHANOL | TEMPERATURE (° C.) | | | | |
| CONCENTRATION | | 0 | 10 | 20 | 40 |
| PURE-WATER SIDE | 0 | 4.4% | 6.1% | 7.9% | 13.2% |
| SET TEMPERATURE | 10 | 3.4% | 4.7% | 6.2% | 10.9% |
| (° C.) | 20 | 2.7% | 3.8% | 5.0% | 9.2% |
| | 40 | 1.8% | 2.6% | 3.4% | 6.6% |

Since the methanol temperature is close to the measured value of the temperature detector 11b-3 of the Peltier device 11b-2 on the methanol side, and the water temperature is close to the measured value of the temperature detector 13b-3 of the Peltier device 13b-2 on the water side, the methanol temperature and the water temperature in Table 1 can be substituted with the measured values of the temperature detectors 11b-3 and 13b-3.

Thus, by adjusting the temperature of each of the Peltier device 13b-2 on the water side and the Peltier device 11b-2 on the methanol side, the methanol concentration can be controlled to 4%.

In the present embodiment, as the material for varying the liquid temperature, the Peltier devices are used, but heaters may be used instead. In this case, sheet heaters that can control temperatures independently of each other are bonded on the flow rate control units 11b-1 and 13b-1 of the chip 23. A heat sink is disposed on the bottom surface of the chip 23. The temperature of each of the flow rate control units 11b-1 and 13b-1 rises in accordance with the heaters being turned ON, and the temperature of each of the liquids flowing through the flow rate control units 11b-1 and 13b-1 also rises. Near each of the sheet heaters, a temperature detector is disposed for exerting feedback control to each heater based on the temperature information from the temperature detector. Lowering the current flowing through the heaters, the temperature lowers because of heat dissipation so as to approximate the heat sink temperature. When the size is of the order of millimeters, the surface area becomes overwhelmingly greater in terms of the ratio between the surface area and the volume of an object, the heat dissipation speed is very fast as compared to a normal level. Accordingly, it is possible to fully exert temperature control solely by heating elements, which are the heaters.

In the present embodiment, the mixing units 15b are implemented by allowing the liquids to pass through the patterns like a maze. However, there are other methods of mixing, such as disposing obstacles in a flow channel, or mixing by irradiating the liquids with ultrasonic wave by an ultrasonic element.

Further, in the present embodiment, while the optical length is 0.2 mm, depending on the wavelength to be used, the optical length may be thicker than 0.2 mm, e.g., 1 mm, 10 mm, or may be thinner than 0.2 mm.

In the foregoing, the description has been given of the dilution example of the methanol with the water. However, the concentration adjustment can be carried out with other liquids.

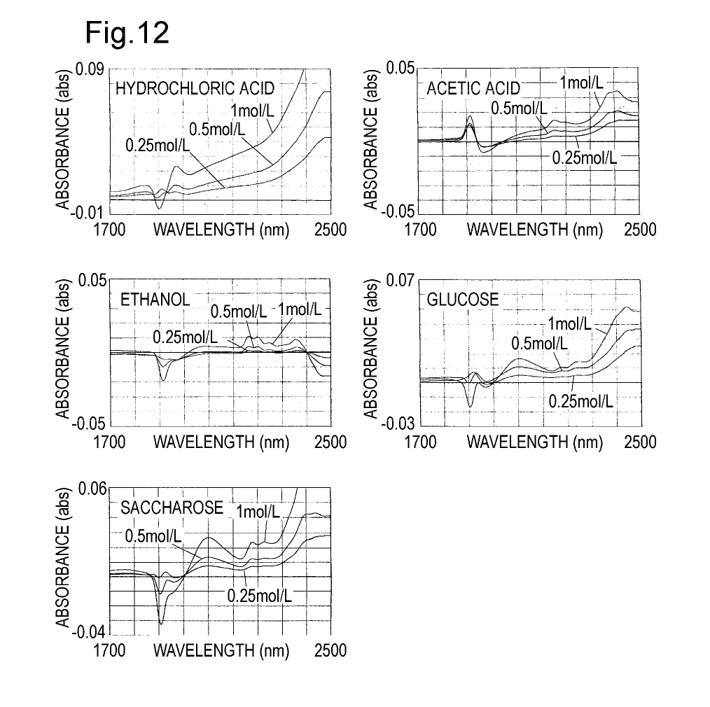

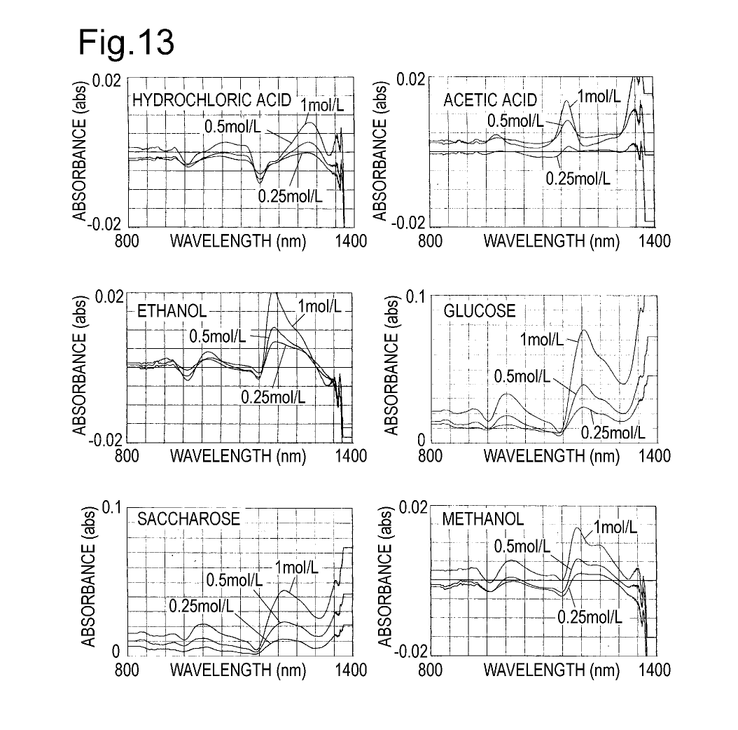

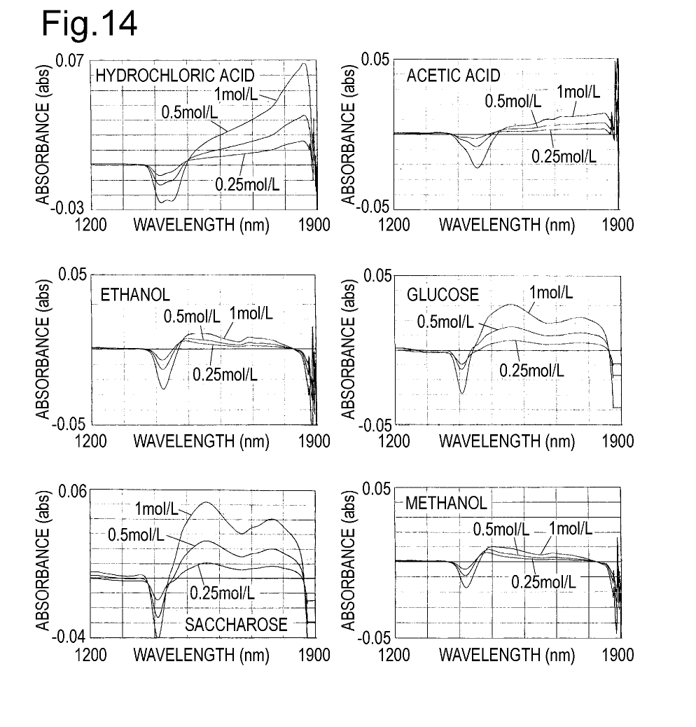

FIG. 12 shows graphs respectively showing a difference spectrum of each of hydrochloric acid, acetic acid, ethanol, glucose, and saccharose, relative to a water spectrum, at wavelengths 1700 nm to 2600 nm. The optical length is 0.2 mm. FIG. 13 shows a graph showing a difference spectrum of each of hydrochloric acid, acetic acid, ethanol, glucose, saccharose, and methanol, relative to a water spectrum, at wavelengths 800 nm to 1400 nm. The optical length is 10 mm. FIG. 14 shows graphs respectively showing a difference spectrum between hydrochloric acid, acetic acid, ethanol, glucose, saccharose, and methanol, relative to a water spectrum, at wavelengths 1200 nm to 1900 nm. The optical length is 1 mm.

In each of FIGS. 12, 13 and 14, the horizontal axis indicates wavelength (nm), and the vertical axis indicates absorbance (abs). FIGS. 12, 13 and 14 show as to the following concentrations of each solution: 1 mol/L, 0.5 mol/L, and 0.25 mol/L.

As shown in FIGS. 11 to 14, there is a specific near-infrared spectrum depending on the type of each liquid. Therefore, using the wavelength that exhibits a characteristic to the corresponding liquid, the present invention can be applied to dilution of solution other than methanol.

Further, the fluid control method and the fluid control device according to the present invention can be used not only for diluting, but also for mixing a plurality of types of liquids. In this case, it may be associated with any chemical reaction.

### Second Embodiment

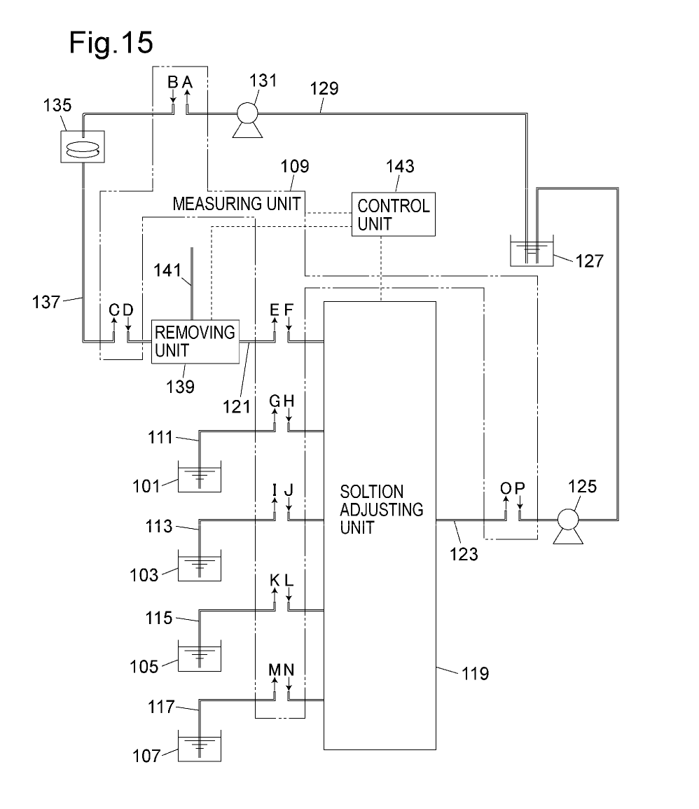

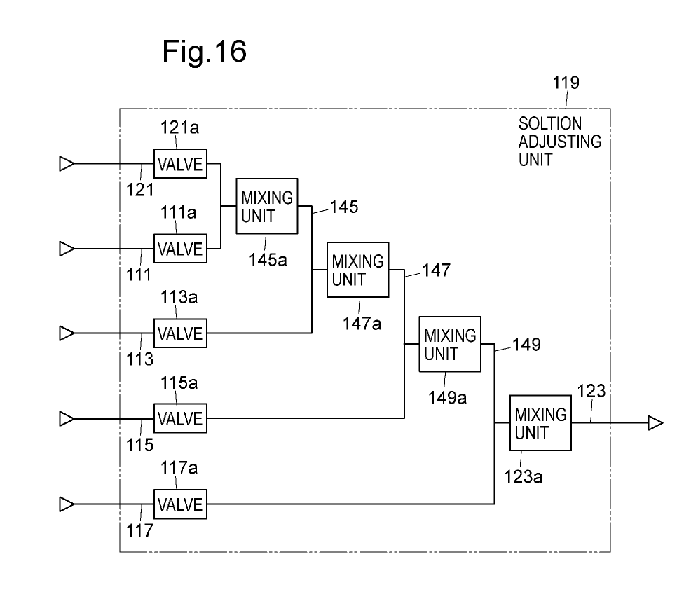

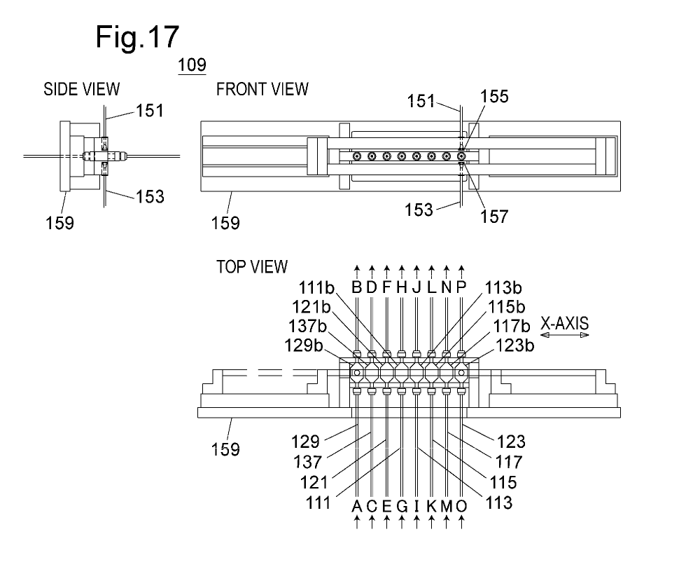

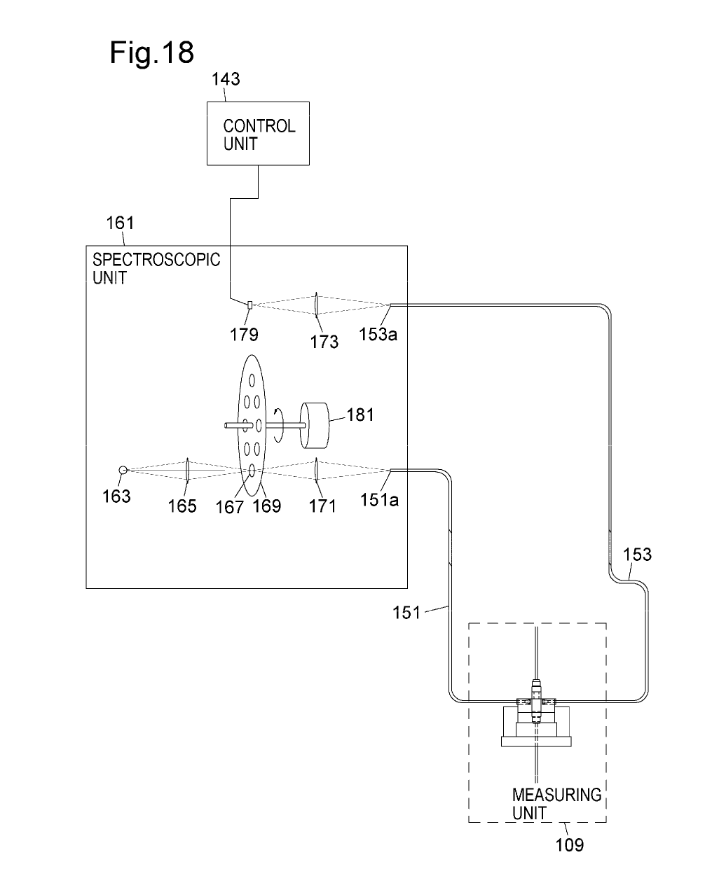

FIG. 15 is a diagram schematically showing an overall structure of another embodiment of the fluid control device. FIG. 16 is a schematic configuration diagram for describing a solution adjusting unit 119 according to the present embodiment. FIG. 17 shows a front view, a side view and a top view for describing the structure of a measuring unit 109 according to the present embodiment. FIG. 18 is a schematic configuration diagram for describing an optical system according to the present embodiment. With reference to FIGS. 15 to 18, a description will be given of the present embodiment.

Containers 101, 103, 105, and 107 are provided. The container 101 contains therein a hydrofluoric acid stock solution having a concentration of 50%. The container 103 contains therein a nitric acid stock solution having a concentration of 70%. The container 105 contains therein a hexafluorosilicic acid stock solution having a concentration of 30%. The container 107 stores therein pure water.

To the containers 101, 103, 105, and 107, one ends of tubes 111, 113, 115, and 117 are connected. Other ends of the tubes 111, 113, 115, and 117 are connected to the solution adjusting unit 119 through the measuring unit 109. To the solution adjusting unit 119, a tube 121 and a tube 123 are also connected. The tube 121 is for transporting an etching solution for regeneration. The tube 123 is for transporting a mixture of liquids obtained by the liquids from the tubes 111, 113, 115, 117, and 121 being mixed in the solution adjusting unit 119. The tube 123 is guided to an etching solution container 127 through the measuring unit 109 and a pump 125.

One end of a tube 129 is connected to the etching solution container 127. The tube 129 is guided to an etching device 135 through a pump 131 and the measuring unit 109. The etching device 135 is for etching semiconductor wafers, and it may be, for example, a spin etching device.

To the etching device 135, a tube 137 for discharging the etching solution having undergone an etching process to the outside of the etching device 135 is connected. The tube 137 is guided to a removing unit 139 through the measuring unit 109. The removing unit 139 is for removing water components and hexafluorosilicic acid in the etching solution. To the removing unit 139, a tube 141 for discharging water vapor and a silicon tetrafluoride gas and the tube 121 for transporting the etching solution are connected. The tube 121 is connected to the solution adjusting unit 119 through the measuring unit 109.

A control unit 143 for controlling operations of the solution adjusting unit 119 and the removing unit 139 based on signals from the measuring unit 109 is provided.

With reference to FIG. 16, a description will be given of the solution adjusting unit 119.

The solution adjusting unit 119 is provided with a tube 145 for merging the tubes 111 and 121 with each other, a tube 147 for merging the tubes 113 and 145 with each other, and a tube 149 for merging the tubes 115 and 147 with each other. The tubes 117 and 149 are merged with each other and connected to the tube 123.

The tubes 111, 113, 115, 117, and 121 are respectively provided with solenoid proportional valves (flow rate adjusting units) 111a, 113a, 115a, 117a, and 121a for adjusting the flow rate of the liquids flowing through therein. The opening degree of each of the valves 111a, 113a, 115a, 117a, and 121a is controlled by the control unit 143 shown in FIG. 15. The tubes 123, 145, 147, and 149 are respectively provided with mixers 123a, 145a, 147a, and 149a for mixing the liquids flowing through the tubes.

With reference to FIG. 17, a description will be given of the measuring unit 109.

As shown in FIG. 15, to the measuring unit 109, the tubes 111, 113, 115, 117, 121, 123, 129, and 137 are guided. As denoted by reference characters A to P, to the tubes 111, 113, 115, 117, 121, 123, 129, and 137, cells 111b, 113b, 115b, 117b, 121b, 123b, 129b, and 137b for optical measurement are connected, respectively. For example, the cells 111b, 115b, 117b, 121b, 123b, 129b, and 137b through which liquids containing hydrofluoric acid or hexafluorosilicic acid flow are made of sapphire, and the other cells 113b and 117b are made of quartz. In these cells, the liquids flow in the direction of the arrows shown near the reference characters A to P, respectively.

A reference character 151 denotes a light transmitter-side optical fiber. A reference character 153 denotes a light receiver-side optical fiber. A reference character 155 denotes a light transmitter-side convex lens. The convex lens 155 condenses the light emitted from an emitting-side end face of the optical fiber 151 and irradiates any of the cells 111b, 113b, 115b, 117b, 121b, 123b, 129b, and 137b with the light. In FIG. 17, the cell 123b is irradiated with the light. The light emitted to the cell transmits through the liquid in the cell, passes through the light receiver-side convex lens 157 to be condensed thereafter, and enters one end face of the optical fiber 153. The eight cells 111b, 113b, 115b, 117b, 121b, 123b, 129b, and 137b are disposed on a stepping motor-mounted slider 159 and can be shifted in a bidirectional arrow direction (X axis) shown in FIG. 17. By an operation of the slider 159, any of the cells 111b, 113b, 115b, 117b, 121b, 123b, 129b, and 137b is stopped at a light emitted plane.

With reference to FIG. 18, a description will be given of the optical system.

A spectroscopic unit 161 is provided. The spectroscopic unit 161 includes: a tungsten lamp 163 being a light source; a convex lens 165; a rotary disc 169 provided with eight interference filters 167; a convex lens 171; a light receiver-side convex lens 173; a light-receiving element 179; and a motor 181 for rotating the rotary disc 169. Light emitted from the tungsten lamp 163 is condensed by the convex lens 165 and passes through the interference filter 167. Here, the interference filters 167 held by the rotary disc 169 disperse light into light of a prescribed wavelength within a range of 800 to 1400 nm.

The light dispersed by the interference filter 167 is condensed by the convex lens 171 and emitted to an entering-side end face 151a of the light transmitter-side optical fiber 151 shown in FIG. 17. The light transmitter-side optical fiber 151 is connected to the measuring unit 109.

As has been described with reference to FIG. 17, the light entered from the entering-side end face 151a of the light transmitter-side optical fiber 151 is emitted from the emitting-side end face of the light transmitter-side optical fiber 151. The light transmits through any of the cells 111b, 113b, 115b, 117b, 121b, 123b, 129b, and 137b through the convex lens 155, and enters the entering-side end face of the light receiver-side optical fiber 153 through the convex lens 157.

The emitting-side end face 153a of the light receiver-side optical fiber 153 is installed in the spectroscopic unit 161. In the measuring unit 109, the light that enters the entering-side end face of the light receiver-side optical fiber 153 enters, in the spectroscopic unit 161, the convex lens 173 from the emitting-side end face 153a of the light receiver-side optical fiber 153 to be condensed, and enters the light-receiving element 179. The light-receiving element 179 converts the entered light into a photocurrent that corresponds to the intensity of the light. The electric signal from the light-receiving element 179 is sent to the control unit 143 shown in FIG. 15.

The rotary disc 169 holds the eight interference filters 167 at circumferential equiangular intervals, and is driven by the driver motor 181 at a prescribed rotation speed, e.g., 1200 rpm (revolutions per minute). The interference filters 167 have prescribed transmitting wavelengths differing from one another and corresponding to the measurement object, within a range of 800 to 1400 nm. When the rotary disc 169 rotates, the interference filters 167 are successively inserted into the optical axes of the convex lenses 165 and 171. The light emitted from the tungsten lamp 163 is dispersed by the interference filter 167 and transmits through the light transmitter-side optical fiber 151, the measuring unit 109, the light receiver-side optical fiber 153, and the convex lens 173, to enter the light-receiving element 179. Thus, from the light-receiving element 179, an electric signal corresponding to the absorbance of light of each wavelength is output.

With reference to FIGS. 15 to 18, a description will be given of regeneration of the etching solution.

Using the pump 131, the etching solution after having its concentration adjusted and stored in the etching solution container 127 is transported to the etching device 135 through the tube 129. In mid course, the etching solution flowing inside the tube 129 is guided to the measuring unit 109 at the places denoted by reference characters A and B. At the measuring unit 109, the etching solution arrives at the cell 129b. By the control unit 143, the slider 159 is operated to shift the optical fibers 151 and 153 to the light transmitting plane of the cell 129b, to measure a concentration of the etching solution flowing inside the tube 129. Thus, a hydrofluoric acid concentration, a nitric acid concentration, a water concentration, a hexafluorosilicic acid concentration each in the etching solution before being used in processing in the etching device 135 are obtained. A method for measuring a concentration of the etching solution may be performed as disclosed in Patent Document 6, for example.

The etching solution having its concentration measured by the measuring unit 109 is transported to the etching device 135, and is used to etch a silicon wafer.

Generally, in the etching process, hydrofluoric acid and nitric acid are consumed, and hexafluorosilicic acid and water are generated. The etching solution used in the processing is collected through the tube 137 by the pump 125 being actuated. The used etching solution flowing inside the tube 137 is guided to the measuring unit 109 to the places denoted by reference characters C and D. In the measuring unit 109, the etching solution arrives at the cell 137b. By the control unit 143, the slider 159 is operated to shift the optical fibers 151 and 153 to the light transmitting plane of the cell 137b, to measure a concentration of the etching solution flowing inside the tube 137. Normally, what is obtained is a measurement result in which the hydrofluoric acid concentration and the nitric acid concentration reduce, and hexafluorosilicic acid concentration and the water concentration increase as compared to those of the etching solution before being used. The control unit 143 calculates the increased concentration amount.

The used etching solution having its concentration measured at the measuring unit 109 is sent to the removing unit 139. The removing unit 139 heats the used etching solution to about 100° C. to 150° C., and reduces the pressure by a vacuum pump. When the liquid temperature is raised, a reduction both in the water and the hexafluorosilicic acid is accelerated. Therefore, the rate of removing the water and the hexafluorosilicic acid per unit time can be adjusted by varying the liquid temperature. The control unit 143 adjusts the processing temperature condition in the removing unit 139 based on the increased hexafluorosilicic acid concentration amount and the increased water concentration amount. The water vapor and the silicon tetrafluoride gas generated in the removing unit 139 are discharged from the tube 141 and sent to a safe place and processed as appropriate.

The etching solution having passed through the removing unit 139 is sent to the solution adjusting unit 119 through the tube 121 as an etching solution before having its concentration adjusted. In mid course, the etching solution before having its concentration adjusted flowing inside the tube 121 is guided to the measuring unit 109 at the places denoted by reference characters E and F. At the measuring unit 109, the etching solution before having its concentration adjusted arrives at the cell 121b. By the control unit 143, the slider 159 is operated to shift the optical fibers 151 and 153 to the light transmitting plane of the cell 121b, to measure a concentration of the etching solution flowing inside the tube 121. Thus, whether an extent of removal of the water and the hexafluorosilicic acid by the removing unit 139 is as expected is checked. The concentrations of the components in the etching solution before having its concentration adjusted, which are obtained by the measurement, are defined as follows: the hydrofluoric acid concentration is f-1; the nitric acid concentration is n-1; the hexafluorosilicic acid concentration is s-1; and the water concentration is w-1.

The etching solution before having its concentration adjusted and after having its concentration measured by the measuring unit 109 is sent to the solution adjusting unit 119. The structure inside the solution adjusting unit 119 has been described with reference to FIG. 16. By the actuation of the pump 125, the liquids are transported from the tubes 111, 113, 115, 117, and 121 side toward the tube 123, through the solution adjusting unit 119.

The hydrofluoric acid stock solution contained in the hydrofluoric acid container 101 is sent to the solution adjusting unit 119 through the tube 111. In mid course, the hydrofluoric acid stock solution flowing inside the tube 111 is guided to the measuring unit 109 at the places denoted by reference characters G and H. At the measuring unit 109, the hydrofluoric acid stock solution arrives at the cell 111b. By the control unit 143, the slider 159 is operated to shift the optical fibers 151 and 153 to the light transmitting plane of the cell 111b, to measure a concentration of the hydrofluoric acid stock solution flowing inside the tube 111. Thus, whether the concentration of the hydrofluoric acid stock solution is at a prescribed concentration, e.g., 50%, is checked. It is defined that the hydrofluoric acid concentration of the measurement result is f-2. Even when the measurement result concentration of the hydrofluoric acid stock solution differs from 50%, depending on an extent of deviation, it can be solved by adjusting the amount of the hydrofluoric acid stock solution mixed at the solution adjusting unit 119.

The nitric acid stock solution contained in the nitric acid container 103 is sent to the solution adjusting unit 119 through the tube 113. In mid course, the nitric acid stock solution flowing inside the tube 113 is guided to the measuring unit 109 at the places denoted by reference characters I and J. In the measuring unit 109, the nitric acid stock solution arrives at the cell 113b. By the control unit 143, the slider 159 is operated to shift the optical fibers 151 and 153 to the light transmitting plane of the cell 113b, to measure a concentration of the nitric acid stock solution flowing inside the tube 113. Thus, whether the concentration of the nitric acid stock solution is at a prescribed concentration, e.g., 70%, is checked. It is defined that the nitric acid concentration of the measurement result is n-2. Even when the measurement result concentration of the nitric acid stock solution differs from 70%, depending on an extent of deviation, it can be solved by adjusting the amount of the nitric acid stock solution mixed at the solution adjusting unit 119.

The hexafluorosilicic acid stock solution contained in the hexafluorosilicic acid container 105 is sent to the solution adjusting unit 119 through the tube 115. In mid course, the hexafluorosilicic acid stock solution flowing inside the tube 115 is guided to the measuring unit 109 at the places denoted by reference characters K and L. In the measuring unit 109, the hexafluorosilicic acid stock solution arrives at the cell 115b. By the control unit 143, the slider 159 is operated to shift the optical fibers 151 and 153 to the light transmitting plane of the cell 115b, to measure a concentration of the hexafluorosilicic acid stock solution flowing inside the tube 115. Thus, whether the concentration of the hexafluorosilicic acid stock solution is at a prescribed concentration, e.g., 30%, is checked. It is defined that the hexafluorosilicic acid concentration of the measurement result is s-2. Even when the measurement result concentration of the hexafluorosilicic acid stock solution differs from 30%, depending on an extent of deviation, it can be solved by adjusting the amount of the hexafluorosilicic acid stock solution mixed at the solution adjusting unit 119.

The pure water contained in the pure water container 107 is sent to the solution adjusting unit 119 through the tube 117. In mid course, the pure water flowing inside the tube 117 is guided to the measuring unit 109 at the places denoted by reference characters M and N. In the measuring unit 109, the pure water arrives at the cell 117b. By the control unit 143, the slider 159 is operated to shift the optical fibers 151 and 153 to the light transmitting plane of the cell 117b, to measure a concentration of the pure water flowing in the tube 117. Thus, whether the liquid contained in the pure water container 107 is pure water is checked. If it is not pure water, the control unit 143 issues an alert.

With reference to FIG. 16, a description will be given of an operation of mixing the liquids.

The etching solution before having its concentration adjusted, which flows inside the tube 121, passes through the solenoid proportional valve 121a. Thereafter, the etching solution merges at the tube 145 with the hydrofluoric acid stock solution supplied from the tube 111. The hydrofluoric acid stock solution is supplied by just a lacking hydrofluoric acid component amount by the opening degree of the solenoid proportional valve 111a being adjusted. The supply amount of the hydrofluoric acid stock solution is determined by the hydrofluoric acid concentration in the etching solution having been measured at the tube 121 and before having its concentration adjusted. The etching solution and the hydrofluoric acid stock solution merged with each other at the tube 145 are mixed by the mixer 145a.

The etching solution having passed through the mixer 145a merges with the nitric acid stock solution supplied from the tube 113 at the tube 147. The nitric acid stock solution is supplied by just a lacking nitric acid component amount by the opening degree of the solenoid proportional valve 113a being adjusted. The supply amount of the nitric acid stock solution is determined by the nitric acid concentration in the etching solution having been measured at the tube 121 and before having its concentration adjusted. The etching solution and the nitric acid stock solution merged with each other at the tube 147 are mixed by the mixer 147a.

The etching solution having passed through the mixer 147a arrives at the tube 149. Here, when the hexafluorosilicic acid concentration in the etching solution having been measured at the tube 121 and before having its concentration adjusted is lower than a target concentration, the hexafluorosilicic acid stock solution is supplied from the tube 115 to the tube 149. The hexafluorosilicic acid stock solution is supplied by just a lacking hexafluorosilicic acid component amount by the opening degree of the solenoid proportional valve 115a being adjusted. The supply amount of the hexafluorosilicic acid stock solution is determined by the hexafluorosilicic acid concentration in the etching solution having been measured at the tube 121 and before having its concentration adjusted. The etching solution and the hexafluorosilicic acid merged with each other at the tube 149 are mixed by the mixer 149a.

The etching solution having passed through the mixer 149a arrives at the tube 123. Here, when the water concentration in the etching solution having been measured at the tube 121 and before having its concentration adjusted is lower than the target concentration, the pure water is supplied from the tube 117 to the tube 123. The pure water is supplied by just a lacking water amount by the opening degree of the solenoid proportional valve 117a being adjusted. The supply amount of the pure water is determined by the water concentration in the etching solution having been measured at the tube 121 and before having its concentration adjusted. The etching solution and the water merged with each other at the tube 123 is mixed in the mixer 123a.

a, b, c, d, and e are adjusted such that the components achieve the target concentrations in the following equations, where: the hydrofluoric acid target concentration is f-0; the nitric acid target concentration is n-0; the hexafluorosilicic acid target concentration is s-0; and the water target concentration is w-0:

[f-0]=(a×[f-1]+b×[f-2])/(a+b+c+d+e)

[n-0]=(a×[n-1]+c×[n-2])/(a+b+c+d+e)

[s-0]=(a×[s-1]+d×[s-2])/(a+b+c+d+e)

[w-0]=(a×[w-1]+e)/(a+b+c+d+e)

Here, a, b, c, d, and e are the values respectively obtained by multiplying the flow rates passing through the solenoid proportional valves 121a, 111a, 113a, 115a, and 117a by the density of the corresponding liquid.

Since the concentrations of the liquids respectively passing through the solenoid proportional valves 121a, 111a, 113a, 115a, and 117a do not vary greatly and, therefore, they each can be regarded as a constant value. That is, since they each can be regarded as a parameter substantially proportional to the flow rate, they each can be regarded as the opening degree parameter of the corresponding solenoid proportional valves 121a, 111a, 113a, 115a, and 117a.

Thus, the etching solution in which the concentration of each component is close to the target value is discharged from the tube 123. In this case, when the d and e parameters adding the moisture and the hexafluorosilicic acid are of great values, it means that the capacity of the removing unit 139 is high. Therefore, control is exerted so as to suppress the same. Further, when the d and e parameters assume minus values, it means that the capacity of the removing unit 139 is low. Therefore, control is exerted so as to raise the same.

The etching solution after having its concentration adjusted flowing inside the tube 123 is guided to the measuring unit 109 at the places denoted by reference characters O and P. In the measuring unit 109, the etching solution having its concentration adjusted arrives at the cell 123b. By the control unit 143, the slider 159 is operated to shift the optical fibers 151 and 153 to the light transmitting plane of the cell 123b, to measure a concentration of each component of the etching solution having its concentration adjusted and flowing inside the tube 123. Thus, whether the concentration of each component of the etching solution having its concentration adjusted attains the target value is checked. When the concentration deviates from the target value, a, b, c, d, and e in the equations stated above are adjusted to correct the deviation at the next regeneration.

The etching solution having its concentration adjusted and having passed through the measuring unit 109 passes through the pump 125 and is temporarily stored in the etching solution container 127. That is, the etching solution container 127 can be dispensed with. That is, by causing the pumps 125 and 131 to operate in synchronization with each other with the same solution sending amount, or by implementing these pumps with one pump, the etching solution having its concentration adjusted and discharged from the solution adjusting unit 119 can directly be sent to the etching device 135. In this case, since the identical liquid flows through the cells 123b and 129b in FIG. 17, one of the cells 123b and 129b is omitted.

In the foregoing, the embodiments of the present invention have been described. However, the material, the shape, the disposition and the like are merely an example, and the present invention is not limited thereto, and various modifications can be made within the scope of the claims of the present invention.

For example, while liquids are used as the fluids to be mixed in the embodiments described above, the fluid control method and the fluid control device of the present invention can be applied to mixing of gases. Here, a plurality of gases to be mixed may be associated with any chemical reaction.

### INDUSTRIAL APPLICABILITY

The present invention can be applied to, for example, preparation of fluids having the set characteristics surely and in real time in adjusting fluids having prescribed characteristics, with micro systems such as a microarray, a micro analysis system, a DNA chip, a microfluidic device, a micro total analysis system or the like, and a semiconductor manufacturing device or the like.

### DESCRIPTION OF REFERENCE NUMERALS

5, 7, 11, 13, 15, 17 flow channel
11a, 13a, 15a measuring unit
11b, 13b flow rate adjusting unit
19 pump
21 control unit
109 measuring unit
111, 113, 115, 117, 121, 123 tube (flow channel)
145, 147, 149 tube (flow channel)
111a, 113a, 115a, 117a, 121a solenoid proportional valve (flow rate adjusting unit)
125 pump
143 control unit

1. A fluid control method, comprising:
mixing a plurality of to-be-mixed fluids flowing inside a respective flow channel;
optically measuring a characteristic of a mixed fluid flowing inside a flow channel; and
adjusting the flow rates of the to-be-mixed fluids such that the mixed fluid achieves a target characteristic based on a result of the measuring.

2. The fluid control method according to claim 1, further comprising
optically measuring a characteristic of each of the plurality of to-be-mixed fluids.

3. The fluid control method according to claim 1, wherein
the optical measurement is a spectrum measurement or one of a transmittance measurement and an absorbance measurement with a prescribed wavelength.

4. The fluid control method according to claim 3, wherein
a wavelength range of the spectrum measurement is one of a near-infrared spectrum of 800 to 2600 nm, a visible radiation spectrum of 400 to 800 nm, an ultraviolet radiation spectrum of 150 to 400 nm, and a combination of them.

5. The fluid control method according to claim 1, wherein adjusting the flow rates of the fluids inside the flow channels is carried out by varying a temperature of each of the fluids flowing in the flow channels, to vary a viscosity of each of the fluids.

6. The fluid control method according to claim 1, wherein the flow channels are formed with a tube.

7. The fluid control method according to claim 1, wherein the flow channels are formed inside a microfluidic device.

8. The fluid control method according to claim 7, wherein
the microfluidic device is a chip including two flat plates clamping a partition plate of a uniform thickness therebetween, such that the flow channels are formed inside.

9. The fluid control method according to claim 1, wherein the fluids are each a liquid.

10. The fluid control method according to claim 1, wherein the characteristic of each of the fluids is a temperature of each of the fluids.

11. The fluid control method according to claim 1, wherein the characteristic of each of the fluids is a concentration of a composition constituting each of the fluids.

12. The fluid control method according to claim 11, wherein
the to-be-mixed fluids are an alcohol solution and water, and the mixed fluid is a diluted alcohol solution.

13. The fluid control method according to claim 11, wherein
the to-be-mixed fluids are a mixed acid before having its concentration adjusted and an acid solution of a component of the mixed acid and water, and the mixed fluid is a mixed acid after having its concentration adjusted.

14. The fluid control method according to claim 13, further comprising the step in which
a moisture content in the mixed acid before having its concentration adjusted is reduced by one of or both of a heating process and a decompressing process.

15. The fluid control method according to claim 13, wherein
the mixed acid before having its concentration adjusted is a solution being the mixed acid after having its concentration adjusted having undergone a prescribed process.

16. The fluid control method according to claim 13, wherein the component of the mixed acid includes at least two out of hexafluorosilicic acid, hydrofluoric acid, nitric acid, acetic acid, phosphoric acid, and sulfuric acid.

17. The fluid control method according to claim 13, wherein the component of the mixed acid includes hexafluorosilicic acid, and further includes at least one of hydrofluoric acid, nitric acid, acetic acid, phosphoric acid, and sulfuric acid.

18. The fluid control method according to claim 16, further comprising the step in which a content of the hexafluorosilicic acid component in the mixed acid before having its concentration adjusted is reduced by one of or both of a heating process and a decompressing process.

19. The fluid control method according to claim 18, wherein
the moisture content in the mixed acid before having its concentration adjusted is also reduced in the step.

20. The fluid control method according to claim 15, wherein the prescribed process is an etching process of a silicon wafer.

21. The fluid control method according to claim 20, wherein
the mixed acid before having its concentration adjusted is the mixed acid after having its concentration adjusted having undergone the etching process of the silicon wafer in the number of predetermined unit pieces.

22. The fluid control method according to claim 20, wherein the etching process is a spin etching process.

23. A fluid control device, comprising:
flow channels for allowing a plurality of to-be-mixed fluids and a mixed fluid of the plurality of fluids to flow;
a flow rate adjusting unit for adjusting a flow rate of each of the to-be-mixed fluids;
a measuring unit for optically measuring a characteristic of the mixed fluid flowing inside the flow channel; and
a control unit for controlling the flow rate adjusting unit such that the mixed fluid attains a target characteristic based on a result of the measurement of the measuring unit, to adjust the flow rates of the to-be-mixed fluids.

24. The fluid control device according to claim 23, wherein
the measuring unit optically measures a characteristic also as to each of the to-be-mixed fluids.

25. The fluid control device according to claim 23, wherein the measurement carried out by the measuring unit is a spectrum measurement, or one of a transmittance measurement and an absorbance measurement with a prescribed wavelength.

26. The fluid control method according to claim 25, wherein
a wavelength range of the spectrum measurement is one of a near-infrared spectrum of 800 to 2600 nm, a visible radiation spectrum of 400 to 800 nm, an ultraviolet radiation spectrum of 150 to 400 nm, and a combination of them.

27. The fluid control device according to claim 23, wherein the flow rate adjusting unit is configured to vary a temperature of each of the fluids flowing inside the flow channel, to vary a viscosity of each of the fluids, and to adjust the flow rates of the fluids inside the flow channel.

28. The fluid control device according to claim 23, wherein the flow channel is formed with a tube.

29. The fluid control device according to claim 23, wherein the flow channels are formed inside a microfluidic device.

30. The fluid control device according to claim 29, wherein
the microfluidic device is a chip including two flat plates clamping a partition plate of a uniform thickness therebetween, such that the flow channel is formed inside.

31-35. (canceled)

36. The fluid control device according to claim 23,
wherein the characteristic of each of the fluids is a concentration of a composition constituting each of the fluids,
wherein the to-be-mixed fluids are a mixed acid before having its concentration adjusted, an acid solution of a component of the mixed acid and water, and the mixed fluid is a mixed acid after having its concentration adjusted, and
the fluid control device further comprising
a removing unit for reducing a moisture content in the mixed acid before having its concentration adjusted by one of or both of a heating process or a decompressing process.

37-39. (canceled)

40. The fluid control device according to claim 23, wherein the characteristic of each of the fluids is a concentration of a composition constituting each of the fluids,
wherein the to-be-mixed fluids are a mixed acid before having its concentration adjusted, an acid solution of a component of the mixed acid and water, and the mixed fluid is a mixed acid after having its concentration adjusted,
wherein the component of the mixed acid includes hexafluorosilicic acid, and further includes at least one of hydrofluoric acid, nitric acid, acetic acid, phosphoric acid, and sulfuric acid, and the fluid control device further comprising a removing unit for reducing a content of the hexafluorosilicic acid component in the mixed acid after having its concentration adjusted by one of or both of a heating process and a decompressing process.

41. The fluid control device according to claim 40, wherein
the removing unit also reduces the moisture content in the mixed acid after having its concentration adjusted.

42-43. (canceled)

44. (canceled)
